(19) United States
(12) Patent Application Publication
(10) Pub. No.: US 2005/0010477 A1
(43) Pub. Date: Jan. 13, 2005

(54) Segmenting and analyzing market data

(75) Inventors: Shaun Michael Sullivan, Mount Pleasant, SC (US); Paul D. Gibson, Mount Pleasant, SC (US); John David Holder, Charleston, SC (US); Lawrence Paul Mishkin, Mount Pleasant, SC (US); Andrew Stephen Sarosy, Charleston, SC (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Blackbaud, Inc., Charleston, SC (US)

(21) Appl. No.: 10/883,231

(22) Filed: Jul. 1, 2004

Related U.S. Application Data
(60) Provisional application No. 60/484,200, filed on Jul. 1, 2003.

(51) Int. Cl. G06F 17/60; G06K 9/34

(52) U.S. Cl. 705/14; 705/15

(57) ABSTRACT

A method of optimizing direct marketing campaigns to a pool of potential donors, comprising defining a plurality of segments, wherein each potential donor is a member of no more than one respective segment, defining and associating a respective package with each segment wherein each package is indicative of the material to be sent to members of the respective segment, activating or fixing in time a first segmentation comprised of one or more of the segments, sending the respective package to members of the respective segments, thereafter associating responses with respective segments in a computer database, calculating a response rate and an average gift amount for each respective segment, and creating a new, optimized segmentation based on the responses obtained from the first segmentation. Another method includes means for ranking segments in a hierarchical fashion and optimizing projected return on investment based on an optimized segment hierarchy.

### CROSS REFERENCE TO RELATED APPLICATION

This application claims the benefit under 35 U.S.C. §119(e) of U.S. Provisional Patent Application Ser. No. 60/484,200 for “Method and System for Optimizing Data for Multidimensional Analysis and Manipulation”, filed Jul. 1, 2003, which is incorporated herein by reference in its entirety.

### FIELD OF THE INVENTION

The present invention relates generally to computer data analysis systems and, more particularly, to methods and systems for collecting, segmenting, analyzing, and forecasting marketing data.

### BACKGROUND OF THE INVENTION

Direct mail marketing has been used for many years as a means of requesting information, selling products, and soliciting funds. In the charitable contribution area, direct marketing is frequently used to educate a consumer about a particular issue and request funds to support the charity's cause. When successful, direct marketing can build a broad base of contributors and reinforce the charity's mission.

Unfortunately, effective direct marketing is one of the more challenging aspects of fundraising. Organizations, such as charities and academic institutions, often find it difficult to become noticed in an ever-increasing competitive environment for donor dollars, minimize acquisition costs, communicate with a large number of constituents with a relevant message, measure direct marketing success, maximize the long-term value of donors, and track progress, including return on investment.

Typically, such organizations use a variety of systems to capture the details of their activities. These systems are generally designed to efficiently record relevant data and instantly update the records in the system affected by each new activity. However, these systems are often not capable of high-speed reporting and dynamic analysis.

Furthermore, most donors have several different connections with a given organization. For example, a regular donor to a university may also be an alumnus, parent of a current student, volunteer coordinator, and community spokesman. With so many affiliations, each donor often has data that is spread across offices, or stored in different software systems and databases, with no way to merge all of the information into a comprehensive view. As a result, individual offices tend to over-solicit or send generic messages, thereby damaging relationships and stifling management strategies.

To compound the problem, many organizations lack the systems or knowledge to perform basic mailing list segmentation, attribute cost-per-dollar raised back to the relevant marketing activity, or plan future campaigns with accurate forecasts.

Thus, many organizations spend thousands of dollars each year on direct mail campaigns without any means for analyzing and reporting actual results. Often, the success or failure of a campaign is therefore based solely on the amount of money donated, without consideration for the cost of the campaign or whether funds can be attributed to a specific mailing.

Therefore, there remains a need for a system that is operative for collecting data and segmenting it to produce a targeted mailing. There is a further need for a system for analyzing the data from a targeted mailing and readily refining subsequent mailings in light of the previous results.

### SUMMARY OF THE INVENTION

The present invention generally relates to a method of collecting data and segmenting it to produce a targeted mailing. Once the results of the mailing are received, they are analyzed and used to refine the next mailing.

In a first aspect of the present invention, a method of optimizing direct marketing campaigns to pools of potential donors, information about the potential donors stored in a first computer database, comprises the steps of (a) defining a plurality of segments for a first direct marketing campaign, wherein each potential donor is a member of no more than one respective segment, (b) defining and associating a respective package with each segment, each package indicative of the material to be sent to members of the respective segment, (c) fixing in time or “activating” a first segmentation comprised of one or more of the segments, information about the first segmentation stored in a second computer database, (d) sending the respective package to members of the respective segments included in the first segmentation, (e) associating responses from the members of the respective segments included in the first segmentation with the information about the first segmentation, (f) based on the responses, calculating a response rate and an average gift amount for each respective segment included in the first segmentation, and (g) creating a second segmentation comprised of one or more segments included in the first segmentation, each segment in the second segmentation having an expected response rate and an estimated gift amount based on the response rate and the average gift amount for each corresponding segment from the first segmentation.

In a feature of the first aspect, the first and second computer databases are the same. In another feature, the first and second computer databases are different.

In yet a further feature, the respective package is sent to all members of the respective segment included in the first segmentation. In another feature, the method further comprises associating a plurality of respective packages with at least one segment thereby to create a test segment. In a further feature, the respective package is sent to a subset of members of the respective segments included in the first segmentation.

Preferably, each “package” identifies an envelope type and its contents. It should be noted that each package also has its own corresponding cost associated therewith.

In another feature, the method further comprises identifying a total cost associated with the first segmentation based on the costs associated with the packages sent in the first segmentation. Preferably, the method further comprises identifying a cost for each segment of the first segmentation based on the costs associated with the packages sent to each respective segment of the first segmentation, calculating a rate of return associated with the first segmentation based on a comparison of the costs for each segment and a total gift amount received from each segment, and calculating an expected rate of return on the second segmentation based on the rate of return for the first segmentation. Alternatively, the method further comprises calculating a rate of return associated with each respective package of the first segmentation based on a comparison of the costs for each respective package, the number of each respective package sent, and a total gift amount received from members who received each respective package and calculating an expected rate of return on the second segmentation based on the rate of return for the first segmentation.

Preferably, the first aspect further comprises, based on the responses, calculating a total amount given by each respective segment included in the first segmentation, and calculating an expected total amount for the second segmentation based on the total amount given in the first segmentation.

In another feature, the method further comprises, based on the responses, calculating a response rate and an average gift amount for each package included in the first segmentation.

In a second aspect of the invention, in a direct marketing campaign system aimed at a pool of potential donors, wherein information about the potential donors is stored in a computer database and wherein a plurality of segments are defined for the direct marketing campaign, a method comprises the steps of (a) arranging the plurality of segments into more than one hierarchy, (b) for each respective hierarchy, assigning each potential donor from the computer database to no more than one respective segment of the respective hierarchy wherein assignment to one of the respective segments is based on the highest segment of the respective hierarchy for which the potential donor qualifies, (c) calculating an expected return on investment for the campaign for each respective hierarchy, (d) selecting the hierarchy with the highest expected return on investment as the optimized hierarchy, and (e) activating a segmentation for the direct marketing campaign having the plurality of segments arranged according to the optimized hierarchy.

In a feature of the second aspect, each segment has a respective expected response rate and expected average donation amount, wherein a respective package to be sent to each potential donor is defined and associated with each respective segment, wherein each package has a cost associated therewith, and wherein the direct marketing campaign has a budget, and wherein the step of calculating an expected return on investment for the campaign includes calculating (i) the number of potential donors in each respective segment, (ii) the cost of packaging associated with each respective segment based on the cost of the package associated with the respective segment and the number of potential donors assigned thereto, (iii) the number of expected responses from each respective segment based on the expected response rate and the number of potential donors in each respective segment, (iv) a total expected gift amount for each respective segment based on the number of expected responses and the expected average donation amount for the respective segment, and (v) the return on investment for each respective segment based on the total expected gift amount and the cost of packaging associated with each respective segment in the segmentation.

In another feature, step (b) of the second aspect of the invention further comprises storing the assignment of each potential donor to the respective segment in temporary computer memory for faster processing of step (c).

In yet a further feature, each segment in each respective hierarchy is defined by a specific criteria and an exclusion of the specific criteria for each higher ranked segment in the respective hierarchy for faster processing of step (c) of the second aspect of the invention.

### BRIEF DESCRIPTION OF THE DRAWINGS

FIG. 1 illustrates an optimized direct mail fundraising system according to the present invention.

FIG. 2 presents a high level overview of the fundraising and feedback process of the present invention.

FIG. 3 presents a more detailed overview of the process of the present invention.

FIG. 4 presents an overview of the segmentation data flow according to the present invention.

FIG. 5 depicts an exemplary segment data structure for use with the present invention.

FIG. 6 presents a schematic representation of an “inactive” segmentation data structure.

FIG. 7 depicts an exemplary segmentation editor screen that may be used to create a new segmentation according to the present invention.

FIG. 8 depicts an exemplary package information input screen that may be used with the present invention.

FIG. 9 depicts an exemplary budget/expense input screen that may be used with the present invention.

FIG. 10 depicts an exemplary segment input screen for manually creating a segment that may be used with the present invention.

FIG. 11 depicts the screen of FIG. 10 having various fields filled in by the user/and or the system.

FIGS. 12-13 depict exemplary segment inputs screen for having the system automatically create segments.

FIG. 14 depicts an exemplary segmentation editor screen that may be used with the present invention.

FIG. 15 depicts an exemplary modification to the “Alumnus” segment, previously shown in FIG. 11.

FIG. 16 depicts the status of an exemplary segmentation after deleting various segments.

FIG. 17 depicts an exemplary screen for activating the segmentation.

FIG. 18 illustrates the status of responses for each segment after activation of the segmentation, but prior to mailing.

FIG. 19 depicts an exemplary updated Summer Mailing 2004 status screen, which indicates the current status of the Summer Appeal 2004 mailing.

FIG. 20 depicts an exemplary screen for copying a previous segmentation that may be used with the present invention.

FIG. 21 depicts a segmentation editor that displays the copied segments and information.

FIG. 22 depicts the status of an exemplary segmentation after deleting various segments.

FIG. 23 depicts an exemplary segmentation criteria input screen that may be used with the present invention.

FIG. 24 depicts an exemplary input screen for defining a test segment that may be used with the present invention.

FIG. 25 depicts an exemplary segmentation editor in which segments can be readily edited and arranged as desired.

FIG. 26 presents an exemplary screen for inputting budget and cost information.

FIG. 27 depicts an exemplary screen for activating a segmentation.

FIG. 28 depicts an exemplary status screen providing the results for each segment.

FIG. 29 depicts an exemplary screen for copying a segmentation.

### DETAILED DESCRIPTION OF THE INVENTION

The present invention is generally directed to methods and systems for collecting data and segmenting it to produce a targeted mailing. The present invention enables data to be readily analyzed and incorporated into subsequent mailings.

While the present invention is generally discussed in the context of fundraising activities associated with a direct marketing campaign, it should be apparent to those of skill in the art that the present invention has broad applicability to any direct marketing application, including the sales of various goods or services, and whether or not such campaign is conducted through regular mail, electronic mail, television solicitation, Internet solicitation, telephone solicitation, and so forth.

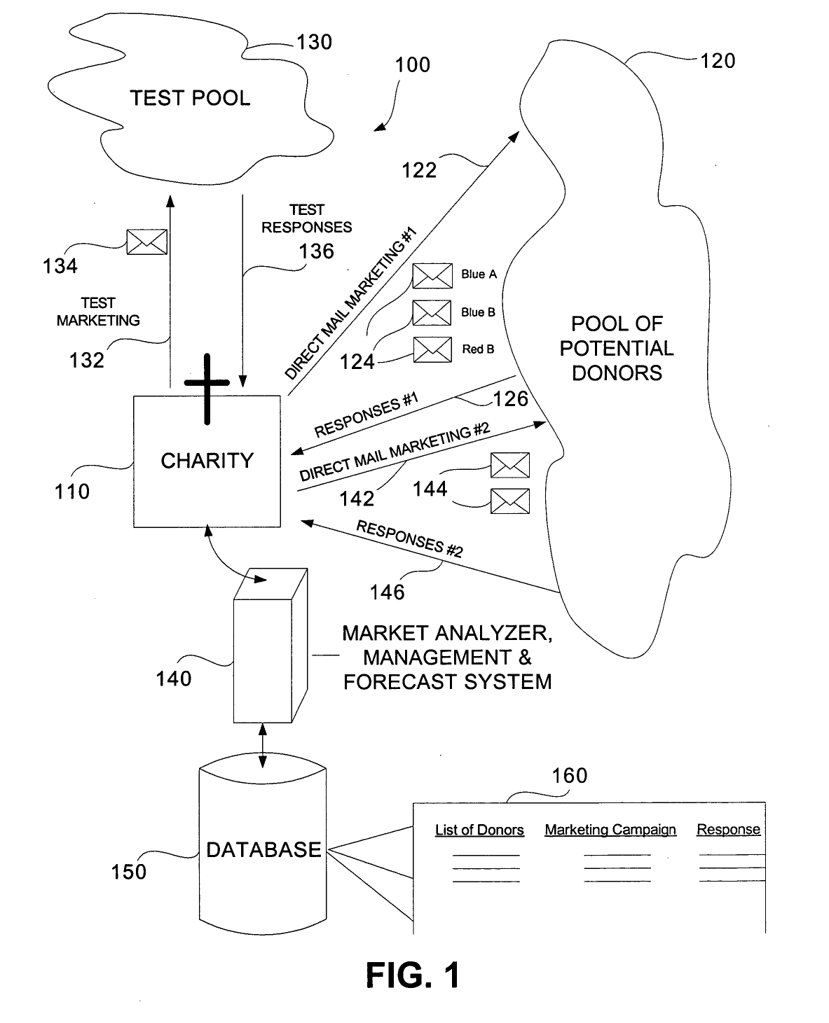

Turning first to FIG. 1, an optimized direct marketing campaign system 100 of the present invention is illustrated. For purposes of this example, we will assume that a charity or other non-profit organization 110 is sending out direct mailings in order to request donations from its pool of potential donors 120. The charity 110 preferably also may use a “test” pool of potential donors 130. The test pool of potential donors 130 is either separate from or a subset (e.g., 0.1-20%) of the charity's standard pool of potential donors 120 and may be used to test a particular campaign or donation request package to determine if it makes sense to expand the campaign or use a particular package with the larger pool 120. To assist with its direct marketing efforts, the charity 110 uses a market analyzer, manager, and forecaster system 140 of the present invention. Such system 140 is preferably one or more computer applications running on a conventional computer system, server, or servers of the charity 110 (or at least accessible by the charity 110). The system 140 has access to one or more databases 150, which maintain therein a list of all potential donors from the pools 120, 130 and the potential donors' relevant personal, contact and financial information, such as address, donation history, etc.

Still referring to FIG. 1, before sending out a standard direct mailing to its pool of potential donors 120, the charity 110 may preferably send out a test mailing 132 to its test pool of potential donors 130. Details 134 of the test mailing 132, such as correspondence type, envelope type, list of potential donors, marketing segment to which each potential donor belongs, etc. are kept in the databases 150 and are shown in table format 160 for ease of reference. Results 136 (i.e., responses from the test pool 130) are received by the charity 110 (or by its authorized representative if the charity 110 outsources this function) and recorded in the database 150. In particular, specific donations are matched up by the analyzer system 140 with each donor from the test pool 130 in such a manner that response results are tabulated and associated with particular correspondence type, envelope type, segment, etc.

The market analyzer 140 then presents recommendations and expected response rates to the charity 110 for each correspondence type, envelope type, segment, etc. based on the results received from the test pool 130. Such feedback is used to formulate a first direct mailing 122 to its standard pool of potential donors 120. Details 124 of the first direct mailing 122, such as correspondence type, envelope type, list of potential donors in the pool 120, and segments to which each potential donor has been associated with are also kept in the database 150 and are shown in table format 160. Similar to a test mailing, a first direct mailing may include “test segments” (not shown), which are preferably used to send different or customized packages to a small subset of one or more segments of the standard pool 120. Test segments may be used to determine the effectiveness of a new or different campaign concept or package without jeopardizing the entire campaign. Results 126 (i.e., responses from the standard pool 120) are received by the charity 110 (or by its authorized representative) and recorded in the database 150. In particular, specific donations are matched up by the analyzer system 140 with each donor from the standard pool 120 in such a manner that response results are tabulated and associated with particular correspondence type, envelope type, segment, test segment, etc.

The market analyzer 140 then presents summary data of response rates to the charity 110 for each correspondence type, envelope type, segment, etc. based on the results received from the standard pool 120. Such feedback is again usable to formulate a second direct mailing 142 at a future date to take advantage of the lessons and information learned by the test marketing and the results of the first direct marketing. Preferably, the charity 110 uses the correspondence types, envelope types, segments, etc. 144 that had the greatest return on investment and response rate during previous mailings. Responses 146 to this second direct mailing are again recorded and analyzed for determining how to structure future direct mailings (not shown).

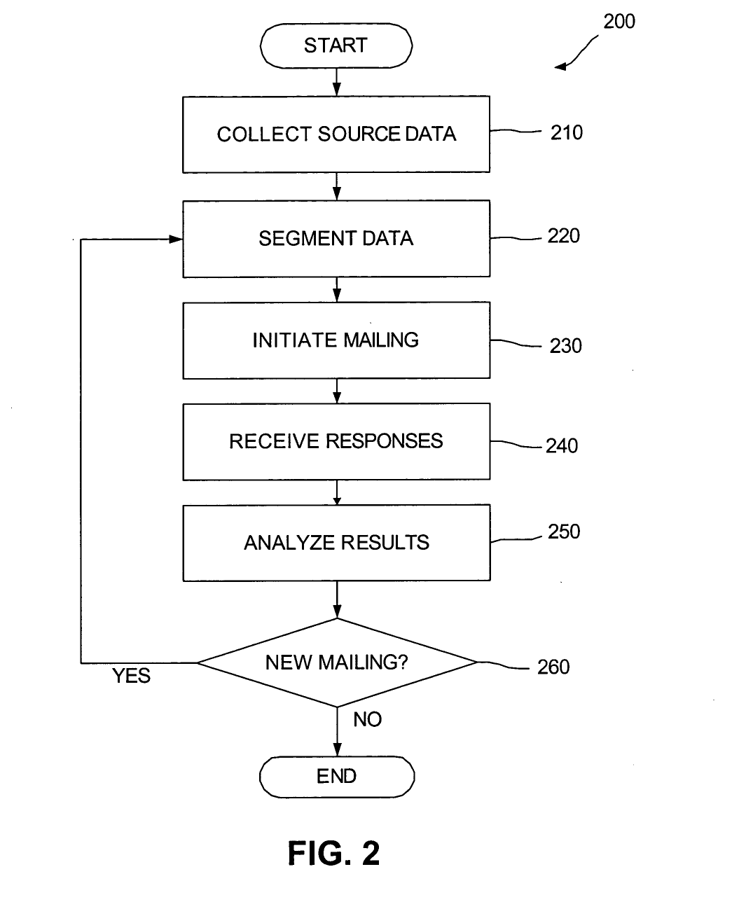

Turning now to FIG. 2, a high level overview of the fundraising and feedback process 200 of the present invention is presented. The process 200 is generally iterative, beginning with collecting 210 potential donor data from various sources. This information preferably includes recipient names, addresses, and so forth. Such data is typically obtained by the charity or fundraising organization from its own database of donors, from public databases, and from third party databases that have such information available for sale or license. Next, the data is segmented 220 according to a variety of charity-defined criteria. Such criteria include age, income, state of residence, type of package to send (e.g., envelope type, specific contents—type of letter, postcard, other promotional items, such as pens, pins, calendars, magnets, etc.), and the like. After the segments are selected for a given mailing, the mailing is initiated 230. Responses to the mailing are received 240 as they come in over an extended period of time. After a sufficient number of responses have been received or after a reasonable period for response has passed, the results of the mailing are then analyzed 250. Optionally, a new mailing is initiated 260. Obviously, at this high of a level of abstraction, the process 200 is similar to conventional methods of segmenting market data, initiating direct mailing, and making decisions on future direct mailings based on anecdotal or piecemeal analysis of results of the direct mailing. In contrast with conventional systems and methodologies, however, the present invention is able to analyze, evaluate, and optimize future mailing based on a complete analysis, evaluation, assessment, and optimization of all of the responses received to a direct mailing rather than based on hunches and antecdotal information that is typically relied upon for evaluating the success or failure of such campaigns.

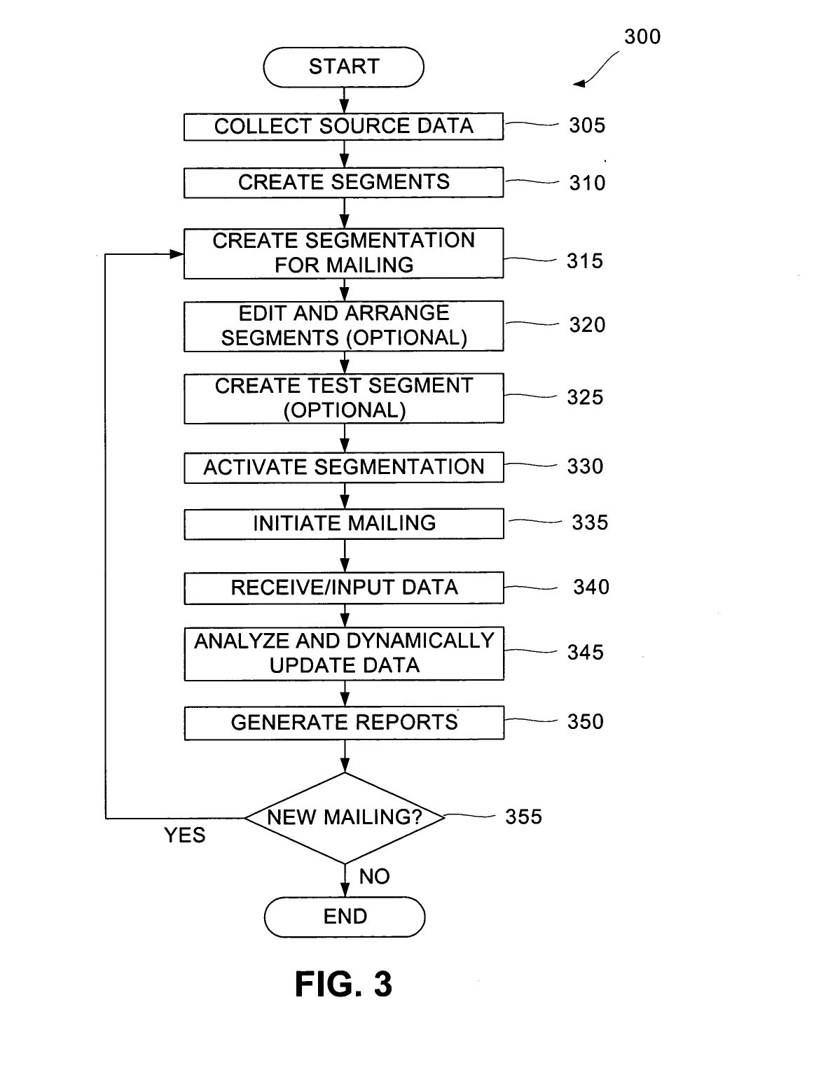

Thus, FIG. 3 presents a more detailed overview of the method 300 of the present invention, which begins to explain why and how the present invention is superior to conventional techniques for managing and optimizing direct mail marketing ventures. First, potential donor (i.e., future recipients of direct mail marketing) data is collected 305 from various sources, as described above. Various means of collecting data for use with the present invention are available and are well known to those skilled in the art. Once such data is collected, it is organized 310 into segments. Segments are characterizations of an individual or class of individuals. Segments are used to divide a larger population of individuals into smaller groups that share a common characteristic. A segment may contain one member or many members. There are an infinite multitude of potential segments that may be used to subgroup and subdivide a potential donor pool, such as, for example, age, income, race, gender, profession, state of residence, and so forth. Thus, for example, a segment for “resident of the state of Wisconsin” would include about 5,440,000 members (for the entire population of Wisconsin; less if the charity's database included merely a subset of the entire population) or a segment for “females in the United States” would include about 144,184,500 members (or less if the charity's database only contained a subset thereof.

Preferably and for reasons that will become apparent hereinafter, segments are processed by the system of the present invention so that each recipient or potential donor belongs to only one segment at any given time. For example, if the system includes two segments, “Female” and “Over 50”, a potential donor could qualify as a member of either or both segments. The system preferably uses a hierarchy of segments, however, to ensure that once a recipient has been included in one segment, such recipient will not be included in additional segments having a lower priority in the hierarchy. For example, if the segments are listed in the hierarchy as “Female”, then “Over 50”, the “Over 50” segment will only include males over 50. If the segments are reversed in the hierarchy so that the “Over 50” segment is before or higher priority than the “Female” segment, the “Female” segment will only include females under 50.

After the data is segmented, a segmentation that will contain a specific, limited group of segments, is created 315 for use in a particular mailing. As will be described in greater detail hereinafter, each separate segment in a specific segmentation is defined by a variety of information. For example, a segment preferably has a name and description for the segment, a package type (having its own costs associated therewith) to indicate what information (and in what format that information will be contained) will be mailed to the potential donor recipient, an expected response rate, an expected donation amount, and so forth. Other information may be included in the segment definition as desired and as will be more readily apparent hereinafter.

Once one or more segments are selected for inclusion in the specific segmentation, the system then enables the user (associated with the particular charity that will be sending the mailing) optionally to edit and arrange 320 the segments to refine the number and type of recipients for a particular mailing. For example, since potential donors can only be in one segment at a time and since segments are ranked in a hierarchy, the system enables the user to move segments up and down in a hierarchical list, as will be described in further detail in connection with the various examples presented herein. When the segments are rearranged in the list, the system dynamically re-calculates the number of recipients in each segment, the cost of the mailing (based on the inputted package type and cost), and the donation amount the charity expects to receive from that segment based on expected rates of return and donation amounts associated with a particular segment. Thus, the system enables the user manually to rearrange segments to optimize return on the cost of mailing, minimize overall expenses, target or exclude a select group of individuals, and to see the impact of changing segment hierarchy on the expected return on investment for the campaign. Alternatively, if requested by the user, the system is configurable automatically to optimize the segment hierarchy/arrangement based on a priority ranking selected by the user, such as highest number of recipients, most cost effective rate of return for a fixed cost, highest donation expected regardless of cost, and the like.

If desired, a test mailing or a test segment may be created 325 to evaluate the effectiveness of a particular mailing. A test mailing and a test segment are different types of strategies for testing the effectiveness of a potential campaign without the cost of a full campaign (if using a test mailing) and without the risk of jeopardizing the effectiveness of “known” techniques or packages for obtaining donations (if using test segments in a full campaign).

For example, a test mailing is an actual “segmentation” (which may or may not include test segments therein). Typically, a test mailing is a merely a copy of a full or complete segmentation that only contains a specified number or percentage of the full or complete segmentation. For example, if a charity or nonprofit organization has never done a mailing or campaign to a particular group or region in which it knows that it has 100,000 constituents, it might be considered reckless to send 100,000 packages (with their corresponding cost) to such a group for an unknown response or result. In such a case, it might make more sense to send a test mailing to a subgroup or sub-portion of that larger group, such as to only 10,000 constituents, to determine what type of response may be expected from the larger group and to determine if it makes sense to send out packages to the remaining 90,000 constituents. In such a case, a segmentation for the 100,000 constituents would be created, but then a “test mailing” segmentation would be made by copying the larger segmentation but only including 10% or 10,000 specific constituents in the test mailing segmentation. If the response to that test mailing is successful, then the charity or nonprofit organization can follow-up with a later mailing to the remaining 90% of the group.

In contrast, a “test segment” is used to send a different package to a group of people in a segment. For example, the charity or nonprofit organization could specify that all “Residents of the State of Utah” get the “Blue package”, but a test segment of 10% would get the “Red package”. This sort of testing addresses the situation in which the charity “knows” that people from Utah respond very well (or at least have responded very well in the past) to the ‘Blue package’, but in which the charity has seen good results from the ‘Red package’ from other segments or groups. Thus, the charity may be interested in seeing if it can get a good or better response from people in Utah using the ‘Red package’, but without risking the known results or success that the charity knows it can achieve using the ‘Blue Package.’ Thus, the charity may want to send 90% of the people the ‘Blue package’ so it will get a certain level of response and send the other 10% the ‘Red package’ to see how they respond. On the next mailing, if the response to the ‘Red package’ is higher than the response to the ‘Blue package’, then the charity will send more ‘Red packages’ to the people in Utah.

After the segments have been selected and prioritized as desired and, optionally, after a test mailing has been conducted and responses obtained thereto, the particular segmentation, with its finalized rankings/hierarchy of segments, are “activated” 330. This means that the direct mail marketing event will take place according to the activated segmentation, without further change (e.g. to segments and packaging types, etc.). Next, an actual direct marketing campaign, in accordance with the activated segmentation, is initiated 335.

Over the next days, weeks, or months, as funds are received, the response data is input 340 into the system database. As data is input and associated with its respective donor (who is associated with a particular segment and package type), the system dynamically calculates 345 the number of responses, the response rate, and the average amount received within each respective segment and package type. The system can be instructed to calculate other information, as desired, and as will be described hereinafter. Examples of such results include the response rates or amounts received of each segment relative to each other segment (e.g. people in the “Over 50” segment donated more than the “Under 20” segment), relative to the expectation (e.g. a 5% response rate from the “Under 20” segment was expected, and only received a 2% response), and relative to the cost of the mailing (e.g. it cost $500 to mail to the “Over 50” segment, and only $5000 was donated by donors within that segment).

Furthermore, the system provides for additional analysis (also at 345), using data structures created during the segmentation process. For instance, the system is able to provide a detailed listing of the people in a given segment that made a donation or purchased a product, and further is able to subdivide the information by some other available data, such as socio-economic status, region, specific age, gender, and package type received.

Likewise, at various times during the response period, reports may be generated 350 by the system, as requested by the user. Multiple reporting options are provided, such as charts, graphs, and tables, in conventional manner.

When the mailing is deemed complete and no additional responses are expected, the analyzed data is advantageously used to initiate, configure, and optimize 355 a new mailing 255. For example, if after a mailing, the actual response rate from a particular segment is 2%, instead of the anticipated 5%, the system affords the user an opportunity to import and/or save that information for more accurate analysis and projection for the next mailing, as will be described in greater detail below.

From the above discussion, it should be clear to those skilled in the art that the present invention provides a significant advantage over other presently available direct marketing systems. The present invention enables source data to be collected and organized into segments, segments to be arranged purposefully into a hierarchy coupled with dynamic calculation of the number of recipients, cost of the mailing, and expected response, and data to be analyzed, reported, and incorporated into a new mailing. Thus, the present invention not only captures and reports data, but provides an efficient and effective means of using the data to refine, configure, and optimize additional mailings and achieve improved return on future mailings.

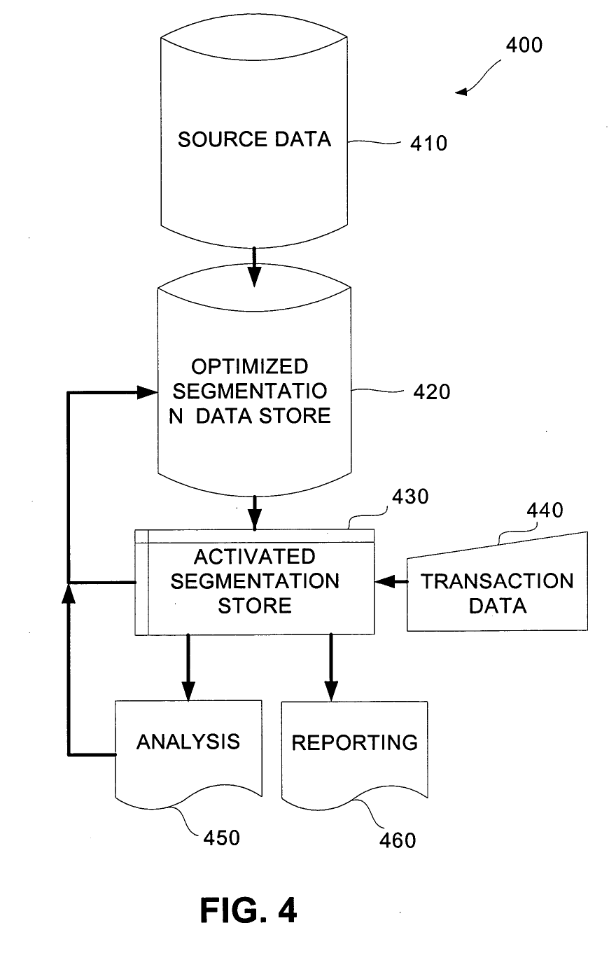

The details of the segmentation process for active and inactive segments are illustrated and discussed in greater detail in FIGS. 4-6 hereinafter.

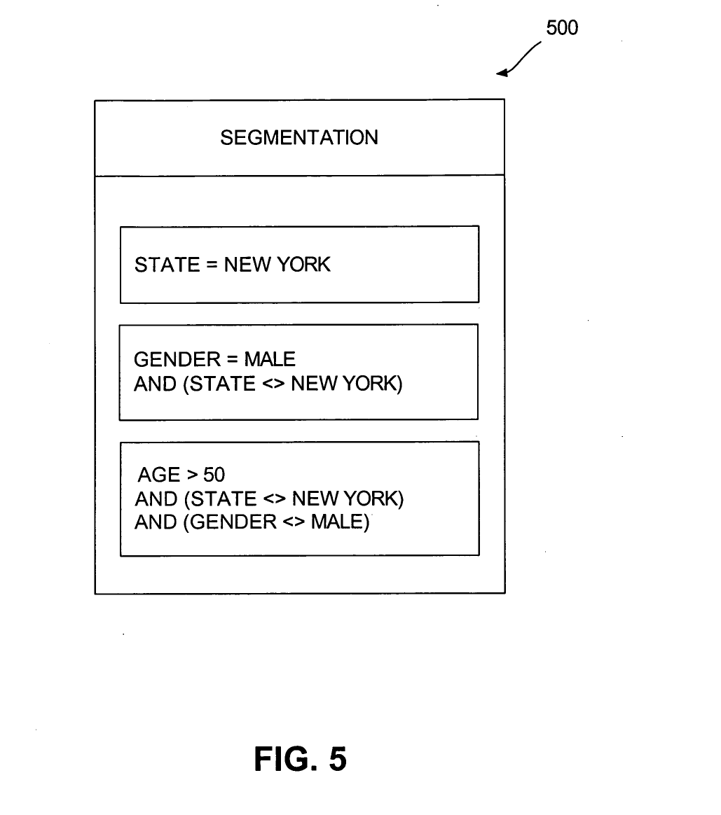

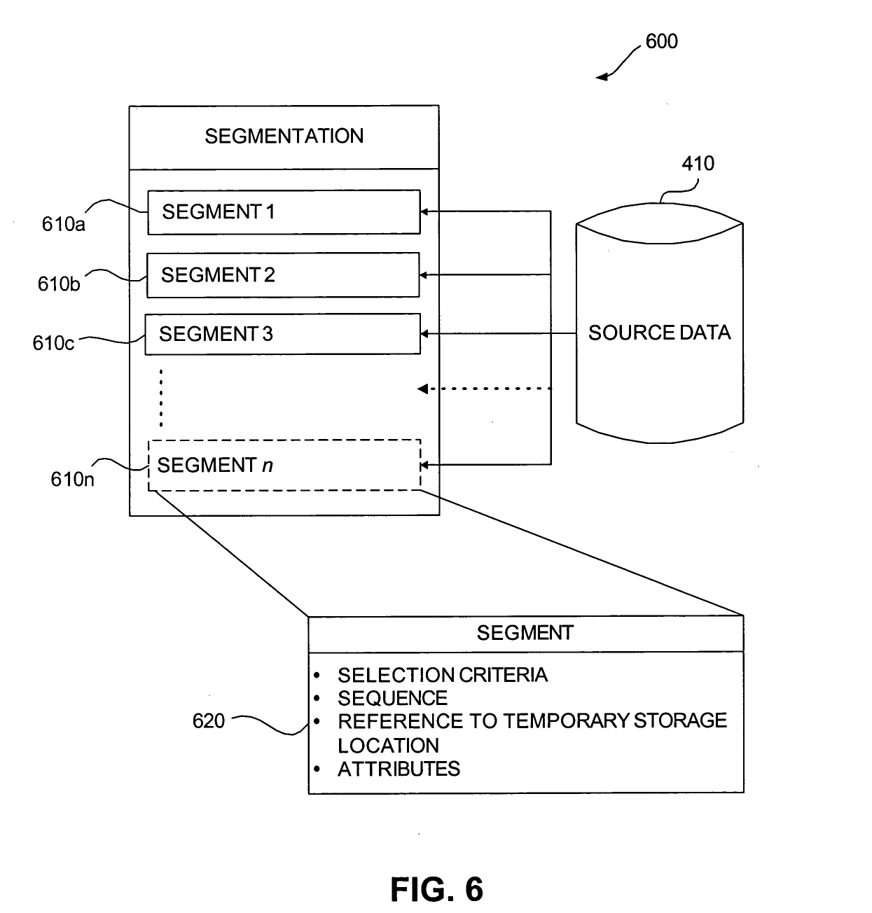

Turning now to FIG. 4, an overview 400 of the segmentation data flow is presented. The segmentation process begins with the source data 410. This data typically contains biographical information for the members of the segmentation, but can contain any additional information about the members as desired. The source data 410 is provided to the optimized segmentation data store 420 where segments (best seen in FIGS. 5-6) are created and manipulated. Once fully prepared, a segmentation is “activated.” Upon activation, pertinent information, such as member identity and segment information, is “fixed in time,” made unmodifiable, and moved to permanent storage in the activated. segmentation data store 17/35 430. As transaction data 440 (such as donation responses) are received, such data is recognized and incorporated into the activated segmentation data store 430, is associated with its corresponding source data 410, and prepared for analysis 450 and reporting 460. The transaction data 440 in the activated segmentation data store 430 is updated to prevent transactions from being included in multiple segmentations. When all of the transaction data 440 has been captured, information from the activated segmentation data store 430 and analysis data 450 are fed back to the optimized segmentation data store 420 for use in analyzing, forecasting, creating, and optimizing a new segmentation for a future campaign. More specifically, when all transaction data 440 has been added to the system and analyzed, a second segmentation can be created based on those results. By copying the relevant information from the activated segmentation data store 430 back into the optimized segmentation data store 420, the new segmentation will contain all of the information from the previous one, augmented with relevant variable information, for example, the expected performance metrics updated to reflect actual performance. The process resumes with this new inactive segmentation. The user is able to analyze this data from an old segmentation to configure and optimize a new segmentation.

The individual segments within a particular segmentation are managed using a set of temporary data structures. FIG. 5 depicts one such exemplary segment data structure 500. Such data structures hold only the information necessary uniquely to identify a member from the source data. This enables the system quickly to move members between segments.

As stated above, segments are ordinal and mutually exclusive. To ensure that a member is present in only one segment at a time, and is assigned to the first segment for which it qualifies in the hierarchy, the data structure for each segment is built using its own selection criteria in addition to the criteria for all preceding segments in the hierarchy. Thus, in the example presented in FIG. 5, the highest segment is “State=New York”, which includes all New York residents, followed by “Gender=Male” (excluding New York males), and the lowest is “Age>50” (excluding Males and New York Residents).

While various means of maintaining the ordered list are possible, the present invention combines use of temporary storage and “repeated” criteria, as described above, which appears to provide the most optimal way of maintaining the ordered list. Unlike permanent storage options, or options in which the criteria are not repeated, the combined use of temporary storage and “repeated” criteria, as provided by the present invention, is a superior technique because it references the source data directly, thereby eliminating the need to move data to a separate location. This enables substantial amounts of data to be processed rapidly and efficiently.

Turning to FIG. 6, a schematic representation of an “inactive” (i.e., a not yet activated) segmentation data structure 600 is depicted. As shown, source data 410 is referenced by 1 to n segments. Each segment 610a, 610b, 610c, . . . , 610n contains enough information 620 to find the unique members for that segment. Additional attributes, such as the name and description, further define the segment. No data is copied from the source data 410 at this stage. Thus, members of a segment are associated with particular segments in temporary computer memory until the segmentation is activated. Keeping such association in temporary memory enables quick rearrangement and reconfiguration of hierarchy of segments until an optimized or desired hierarchy has been selected by the user or automatically chosen by the system. Once the hierarchy has been finalized, the segmentation can then be activated (ie. fixed in time) and stored in permanent memory, as shown in FIG. 5.

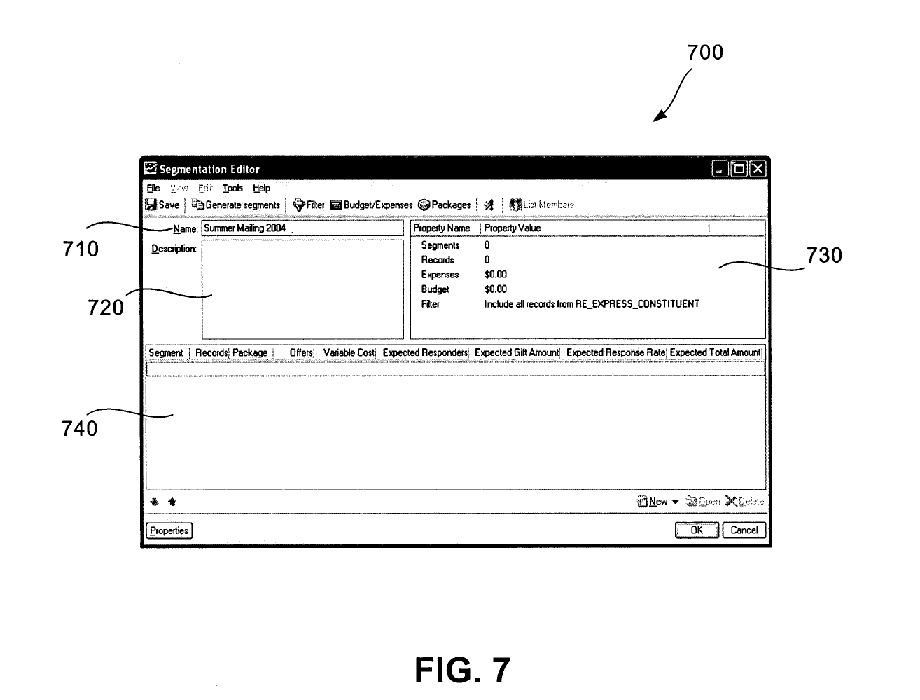

FIGS. 7-22 present a first exemplary direct marketing campaign using an exemplary system according to the present invention. FIGS. 7-22 illustrate this first exemplary campaign through a series of screen shots, which will be described in greater detail hereinafter. It should be understood when viewing these screen shots that source data has already been provided to the system.

FIG. 7 depicts an exemplary segmentation editor screen 700 that is used to create a new marketing segmentation. First, a name for this particular direct marketing campaign (i.e., segmentation) is input into the name field 710. In this example, “Summer Mailing 2004” is chosen. If desired, a more detailed description may then be provided in the “Description” field 710. Summary statistics are shown in field 730 and segment details (not yet obtained) are shown in field 740. Such statistics and details may be shown with a zero value or as empty fields.

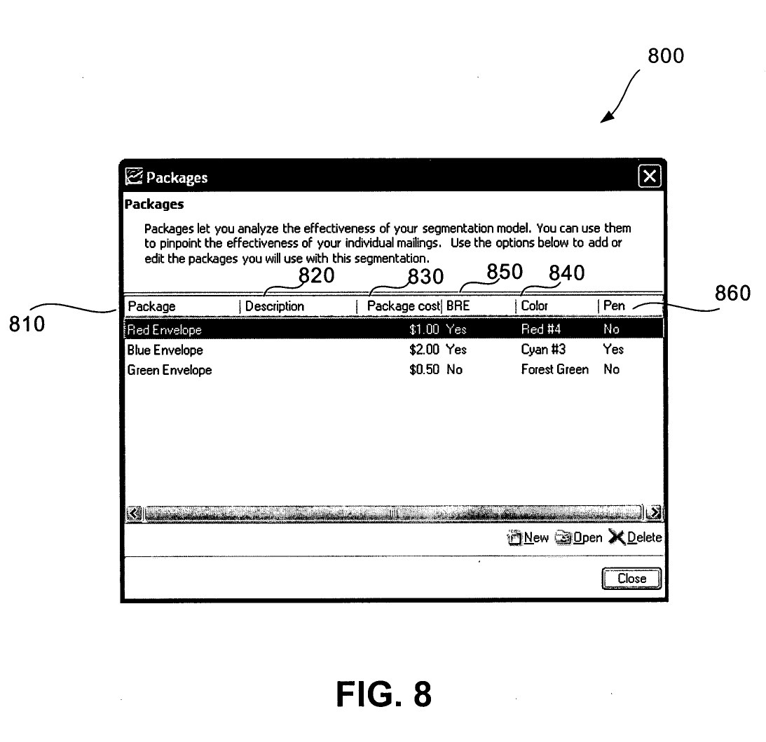

Next, package information is input into the system. As stated previously, a package is the actual item that will be mailed to each potential donor. A package must have a name and a cost associated therewith. A package can also have additional user-defined or selected properties. An exemplary package information input screen 800 is shown in FIG. 8. In this example, a package name 810, description 820, and cost 830 are input by the user, in addition to other customizable information, such as the color 840 of the package, whether a business reply envelope (BRE) 850 is included with the mailing, and whether a token gift 860, such as a pen, is included in the mailing, and the like. Packages may be added, edited, or deleted by the user as needed. Any number of packages may be provided. As explained at the top of the screen shot, packages enable the charity or nonprofit organization to analyze the effectiveness of a segmentation model by pinpointing the effectiveness of each type of mailing.

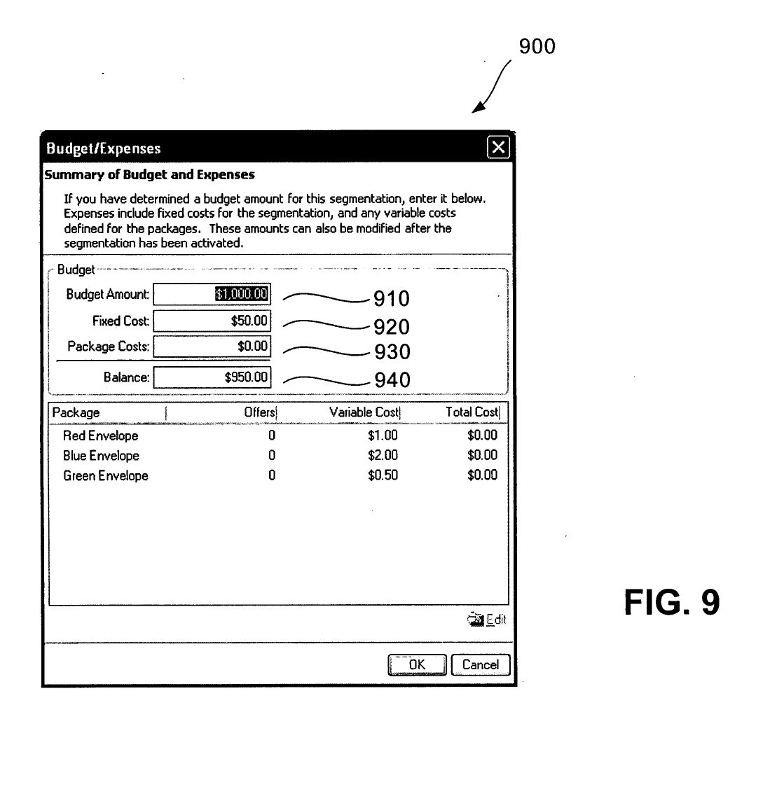

Next, the budget/expense information for the campaign is input into the system. The budget/expense information is used to determine whether the cost of a particular mailing will exceed any budgetary constraints imposed upon the organization. An exemplary budget/expense input screen 900 is depicted in FIG. 9. In this instance, the total campaign budget amount 910, any fixed costs 920 associated with the campaign, and package costs 930 are input. Since no segments have been created at this point, the package costs 930 are reflected as $0.00. As segments are created and packages associated therewith, the system will automatically update the package costs value 930. The system then calculates the current or remaining balance 940, positive or negative, after subtracting fixed costs and package costs from the budget amount.

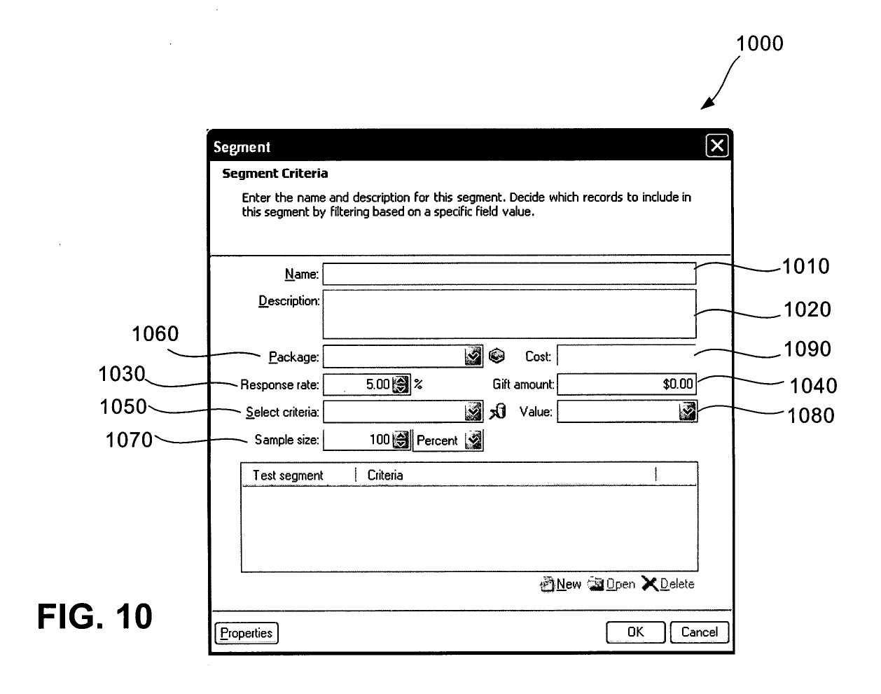

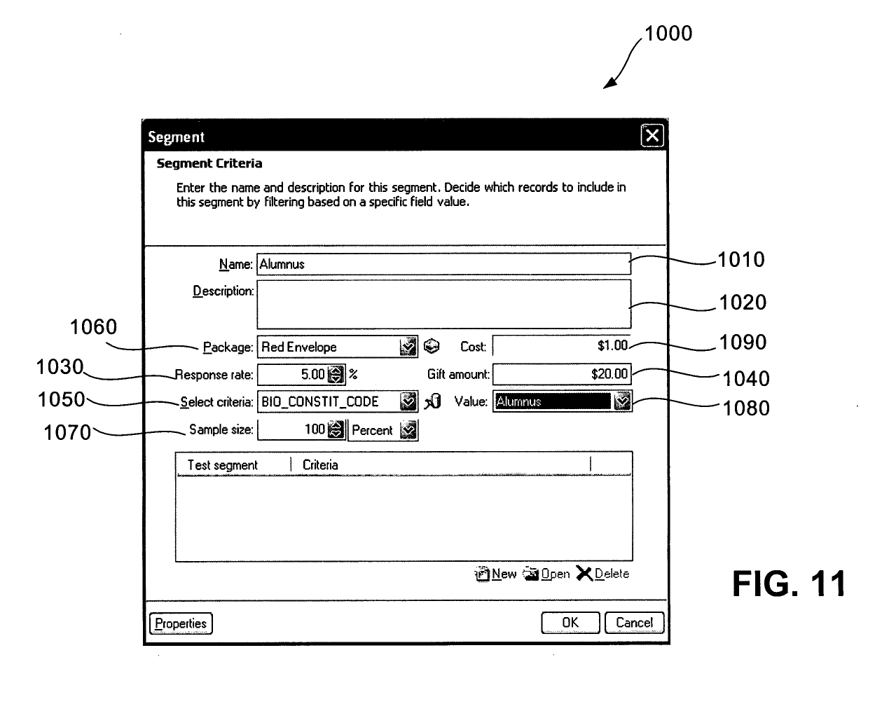

Next, the segments are generated. Segments may be created manually or automatically. An exemplary segment input screen 1000 for manually creating a segment is shown in FIGS. 10 and 11. FIG. 10 illustrates the various fields at their default values. FIG. 11 illustrates some of these fields filled in by the user and/or by the system. To create the segments manually, the name and description for the segment are input into the name and description fields 1010 and 1020, respectively. In addition, the package type field 1060 provides the user with a pull-down menu from which to select which package type this segment will receive. The pull-down menu includes all available package types that have been previously created by the user using package information input screen 800, from FIG. 8. The user is also able to input expected response rates (expected percentage of donors to respond) and expected average gift amounts for this segment in fields 1030 and 1040, respectively.

The “Sample Size” pull down menus 1070 enable the user to artificially limit the size of the segment (below its maximum size) by a percentage of the whole or by a fixed number.

The “Select criteria” field 1050 includes a pull-down list of general category headings for potential donors. For example, as shown in FIG. 11, the “Select criteria” field 1050 may include entries such as “BIO_CONSTIT_CODE” (which represents the Constituent code), “STATE” (not shown), or “AGE” (not shown). Once the criteria is selected, the “Value” field 1080 is populated with the various values that have been predefined for the respective criteria. Thus, as shown in FIG. 11, once the “BIO_CONSTIT_CODE” criteria is selected in field 1050, the “Value” pull-down menu 1080 may include such entries as “Alumnus”, “Friend” (not shown), or “Member” (not shown).

As is also shown in FIG. 11, the user has named this particular segment, “Alumnus” in field 1010. In addition, the user has selected package type “Red Envelope” in pull-down menu 1060, which causes cost field 1090 automatically to show the cost associated with the red envelope package type, which, in this example, is $1.00. In this example, the user has also indicated that the expected average gift amount for this segment is $20.00, as shown in field 1040 of FIG. 11.

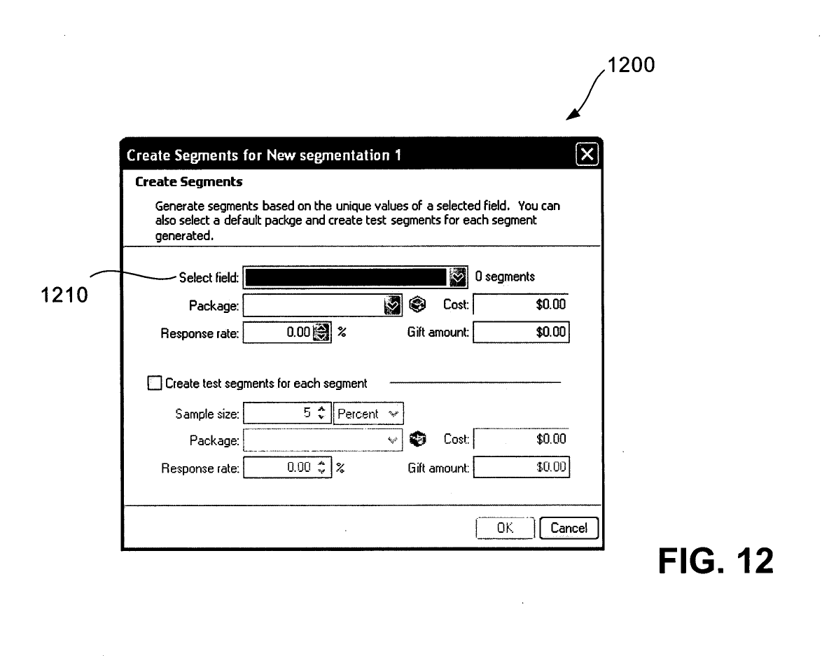

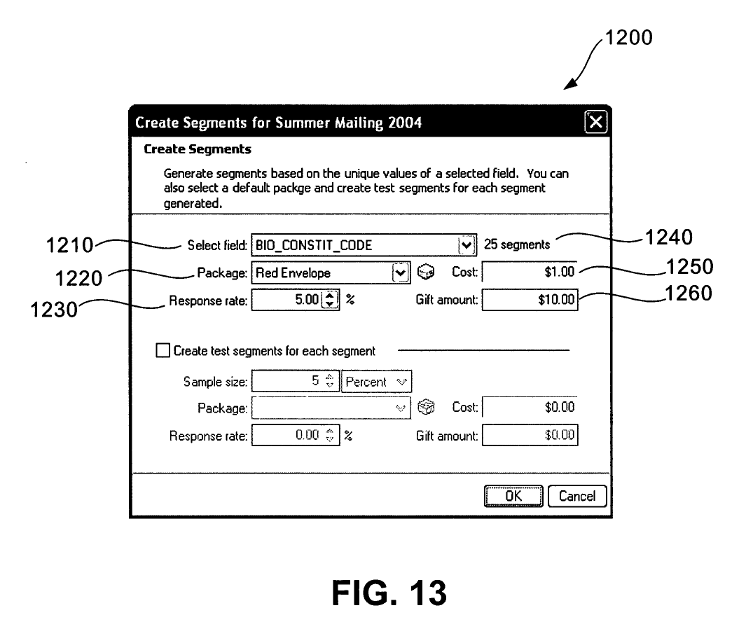

Alternatively, the segment may be generated automatically. An exemplary segment input screen 1000 for having the system automatically create segments is shown in FIGS. 12 and 13. Segments are created by selecting one of the predefined fields 1210 associated with the source data. By doing so, segments will be automatically generated for each distinct value in that field. The predefined fields generally correspond with the criteria values 1080 from FIGS. 10 and 11.

Alternatively, the user can input one of the criteria values (corresponding with field 1050 from FIGS. 10 and 11. By doing so, each possible value associated with the criteria (in this case, 25) generates its own segment. For example, as shown in FIG. 13, if “BIO_CONSTIT_CODE” is selected from the “Select field” menu 1210, this creates 25 segments (as indicated at 1240). In this example, each of the 25 segments will receive the Red Envelope package at a cost of $1.00 each, as shown in fields 1220 and 1250, respectively. The expected response rate is 5.00% and the expected donation amount is $10, as shown in fields 1230 and 1260, respectively.

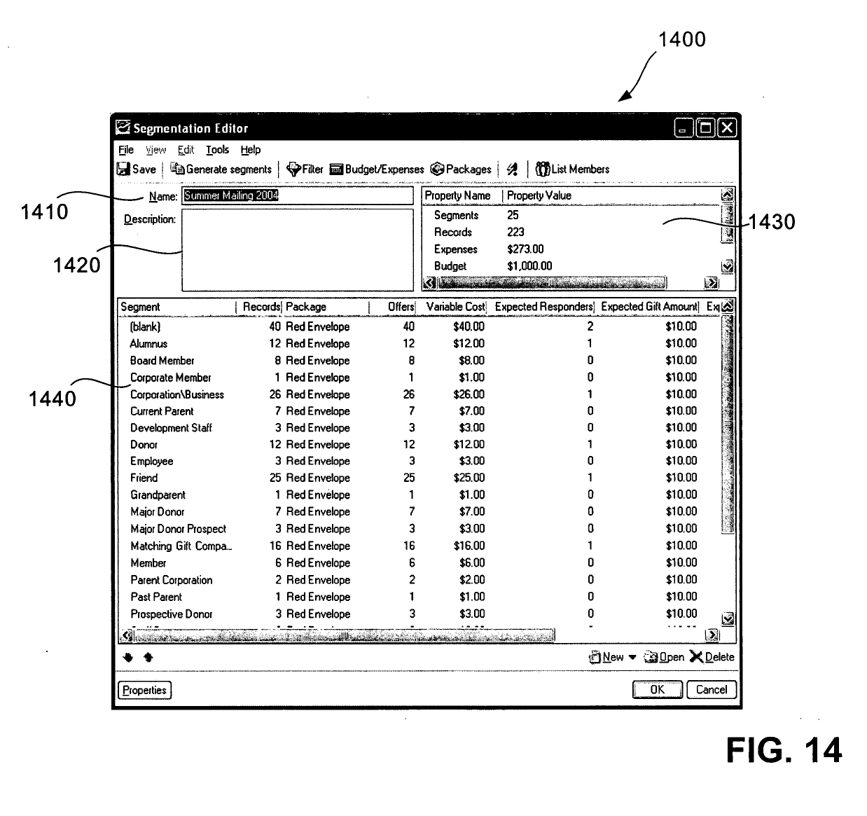

FIG. 14 depicts an exemplary segmentation editor screen 1400, similar to the screen 700 from FIG. 7, that is used to edit the marketing segmentation. The previously-defined name for this particular direct marketing campaign (i.e., segmentation) is shown in field 1410. Summary statistics are again shown in field 1430 and segment details (now obtained) are shown in field 1440. For example, field 1440 depicts each of the 25 segments generated by selecting “BIO_CONSTIT_CODE” in field 1210 of FIG. 13. Each segment is shown in detail (number of records, i.e., potential donors), package type, number of offers to be sent, cost for the package for that segment, expected responders and expected average gift amount for that segment, expected total gift amount for that segment, and expected rate of return for the segment. Each segment, such as the one for “Alumnus” 1420 is also selectable for modification or further editing in conventional manner.

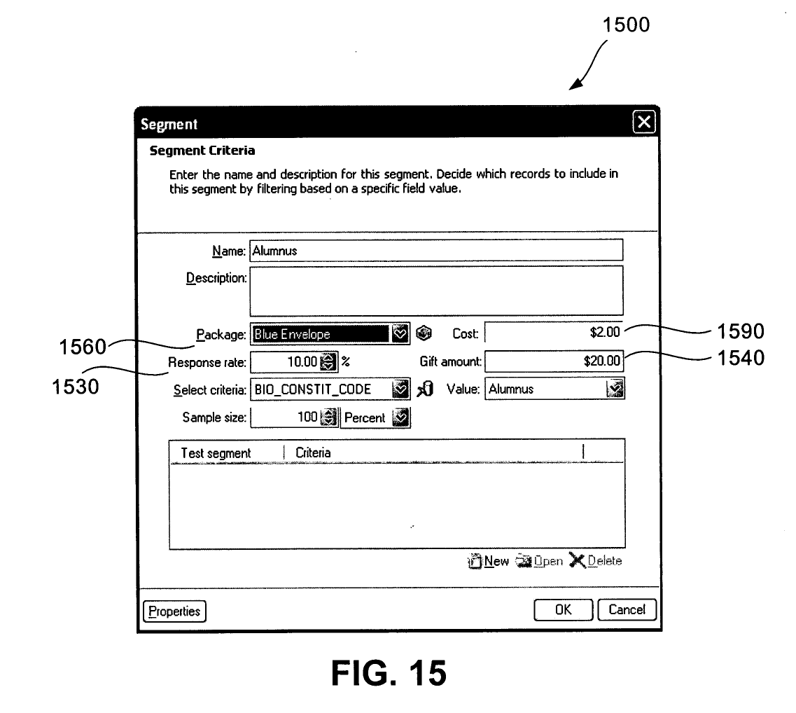

FIG. 15 depicts an exemplary modification 1500 to the “Alumnus” segment, previously shown in screen 1000 of FIG. 11. In this example, the package type 1560 has been changed to “Blue Envelope” (from “Red Envelope”), which automatically changed the cost 1590 to $2.00 (which is the cost assigned to Blue Envelopes). In addition, the response rate 1530 has been changed to 10.00% (from a previous 5.000/%), and the expected gift amount 1540 has been changed to $20.00 (from a previous $10.00).

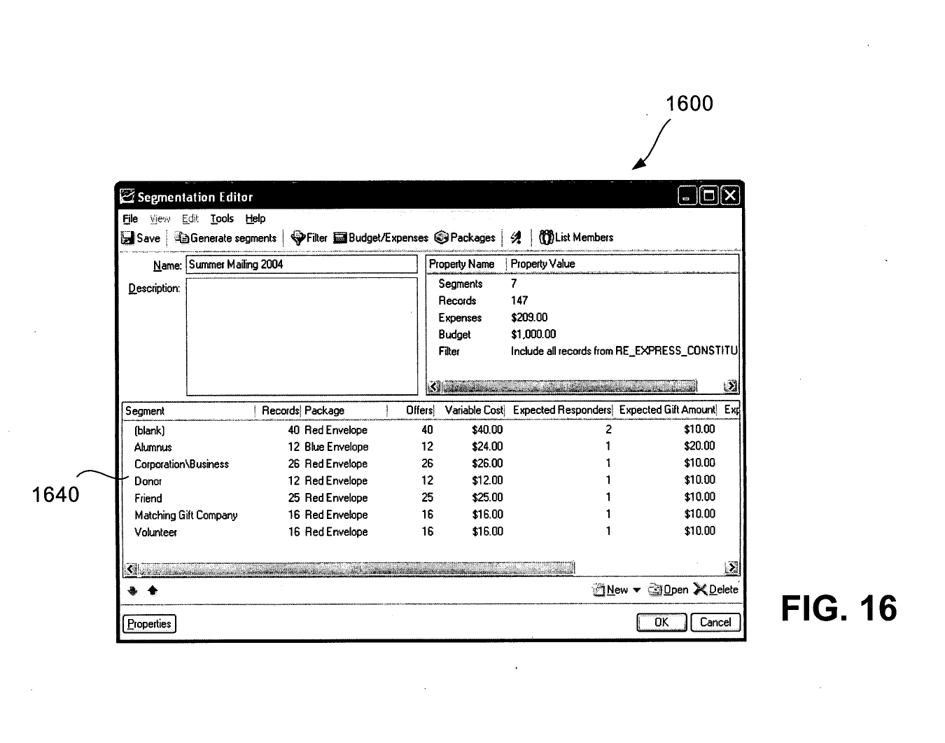

In some instances, it might be desirable to delete a segment (i.e., not mail to particular groups of people). For instance, as shown in FIG. 14, many segments show an expected response rate of 0. If no response is expected from these segments, it might be advantageous to devote resources to other segments or other mailings. Thus, if the segments with a 0 response rate are deleted, only seven segments remain in field 1640 of screen 1600, as shown in FIG. 16. If the budget will allow, some segments might, for example, be further edited to send a more expensive package.

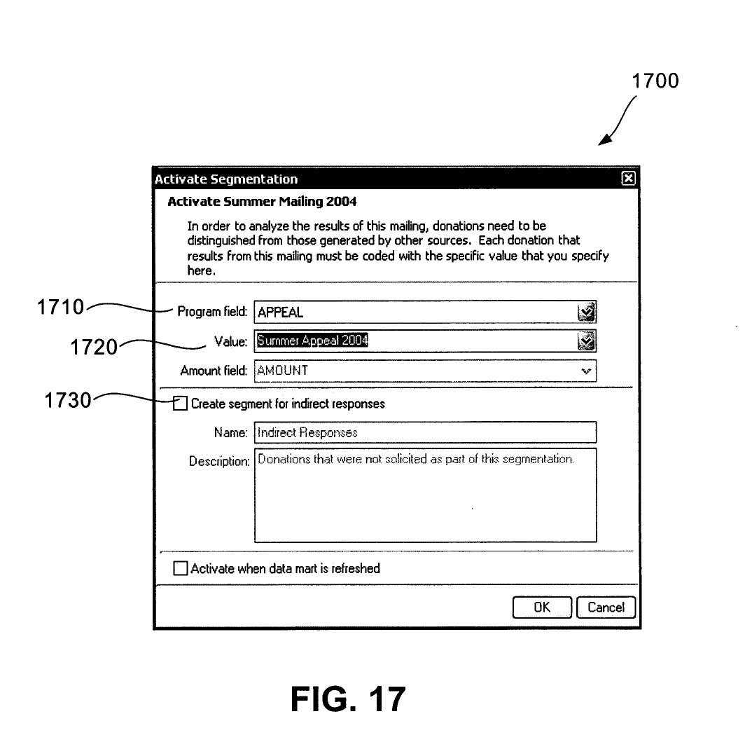

After generating the segments, the segmentation is manually “activated”. Activating the segmentation “locks” in the segments as defined and prepares data structures that will be used for analyzing the results as responses and donation data are received. As gifts are received, the dollar amount will be attributed to the appropriate segment. Turning now to FIG. 17, an exemplary screen 1700 for activating the segmentation is provided. The type of mailing is selected in the “Program field” field 1710, in this instance, “APPEAL”. The value 1720 is then selected, in this instance, “Summer Appeal 2004”. Thus, any potential donor that has the text “Summer Appeal 2004” in the APPEAL field will be included in this segmentation. Use of the “Program field”code 1710, such as “APPEAL”, enables the user to have multiple mailings in process at a given time, each with a different value. For example, an appeal could be run for the “2004 Annual Campaign” at the same time as the “Summer Appeal 2004” with incoming donations being routed to the correct segment.

FIG. 17 also provides a checkbox 1730 optionally to “Create a segment for indirect response”. An indirect response is a donation received from a person who was not directly solicited. For example, a recipient may pass the “Red Envelope” package to a friend who instead donates. Since the donor did not receive the package directly, he or she is not associated with any particular segment. By checking the “Create segment for indirect response” box, a segment will be created to track any incoming data from indirect sources.

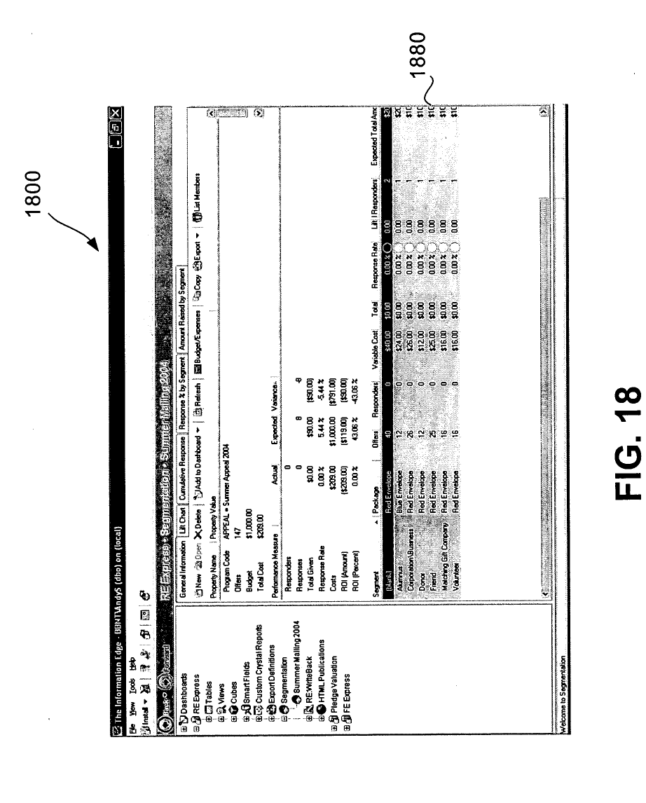

After initially activating the segmentation, the segments that have not met their expected goal may be flagged, highlighted, or otherwise noted, if desired. For example, status screen 1800 of FIG. 18, illustrates the status of responses for each segment after activation of the segmentation but prior to mailing. Thus, segment status field 1880 shows that there have been no responders yet for any segment. Also, each segment may be highlighted in a color (e.g., red) to indicate that each segment has not (yet) made its goal. Other colors may be used to indicate different levels of response.

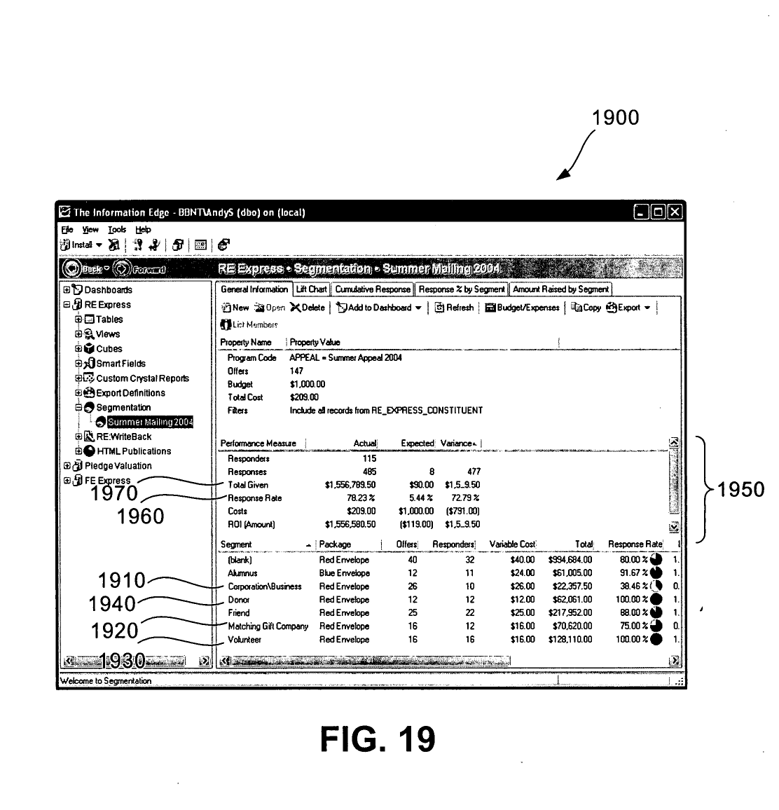

The packages are then mailed. As gifts are received, the dollar amounts are attributed to the appropriate segment. The properties of each segment are then modified to indicate the progress of the mailing. FIG. 19 depicts an exemplary updated Summer Mailing 2004 status screen 1900, which indicates the current status of the Summer Appeal 2004 mailing. Various information can be readily discerned from a cursory-review of this status screen 1900. For instance, the “Corporate/Business” segment 1910 has a relatively low response rate with only 10 responders of 26 total mailings. Further, the “Matching Gift Company” segment 1920 has the second lowest response rate at 75.00%. Additionally, both “Volunteers” 1930 and “Donors” 1940 have a 100% response rate. (This would not be atypical, since volunteers and previous donors are likely to donate.) Field 1950 tabulates the expected versus actual response rates as well as return on investment of the mailing. For example, the estimated expected response rate 1960 and total amount given 1960 was too low for this group of recipients. The estimated response rate was originally 5.44% but the actual response rate is currently at 78.23%. The estimated average donation amount was $90.00 but the actual average amount received was $1,556,789.50.

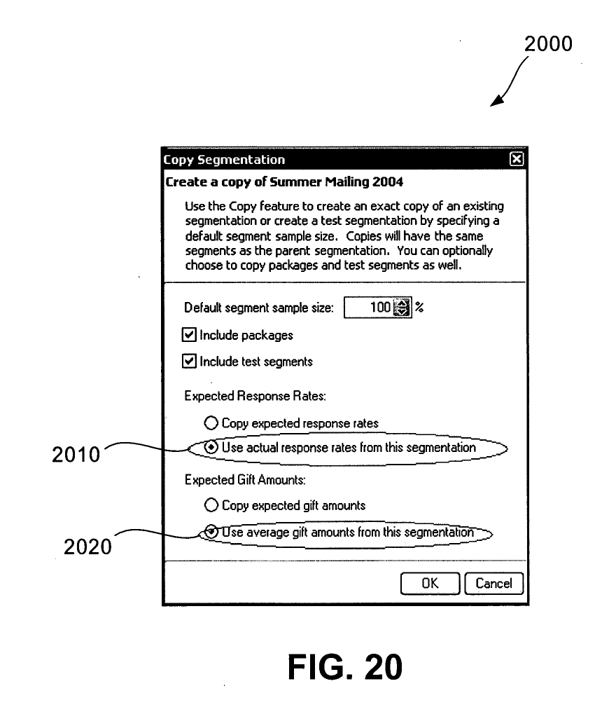

Based on the information compiled in the Summer Mailing 2004, a new segmentation can now be generated with more accurate estimates and projections. If desired, the segmentation previously used can be copied into a new segmentation. FIG. 20 depicts an exemplary screen 2000 for copying the previous segmentation. The system enables the user to copy the segments and package information into the new segmentation. Further, the system enables the user to automatically update the response rates, as indicated at 2010, and/or the expected gift amounts, as indicated at 2020, for each segment based on the actual values of the previous mailing.

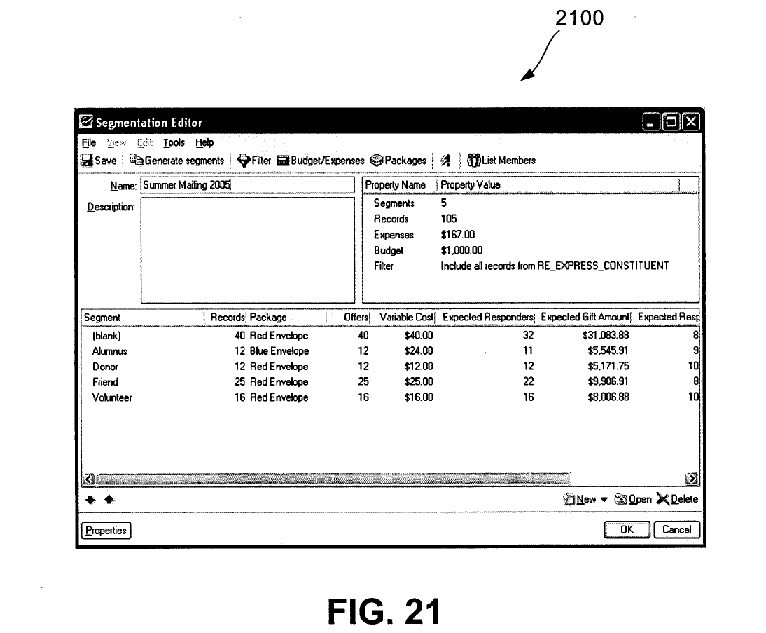

Next, in FIG. 21, the system displays the copied segments and information in a segmentation editor 2100.

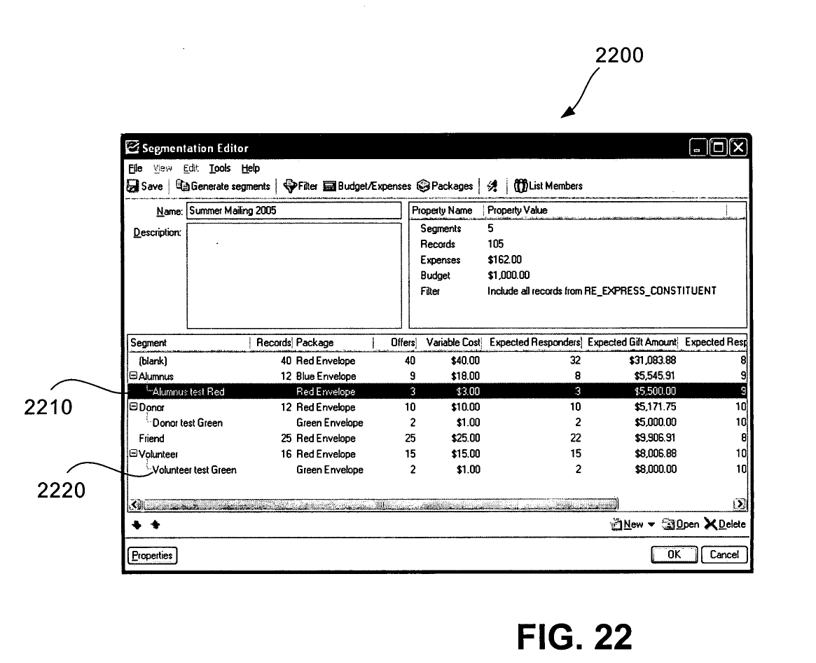

The system then enables the user to edit and arrange segments, as before. In FIG. 22, since the “Corporation/Business” and “Matching Gift Company” responses from the previous segmentation were relatively low (see FIG. 21), these segments are removed. Furthermore, the “Alumnus” segment previously received the “Blue Envelope” package, and there was a 91% response rate. In this mailing, a test segment 2210 is created to evaluate the response level of the “Red Envelope” package. Also, a test segment 2220 is created to determine the effectiveness of the “Green Envelope” package, which can be obtained for a lower cost. With these changes, the new segmentation may then be activated and mailed.

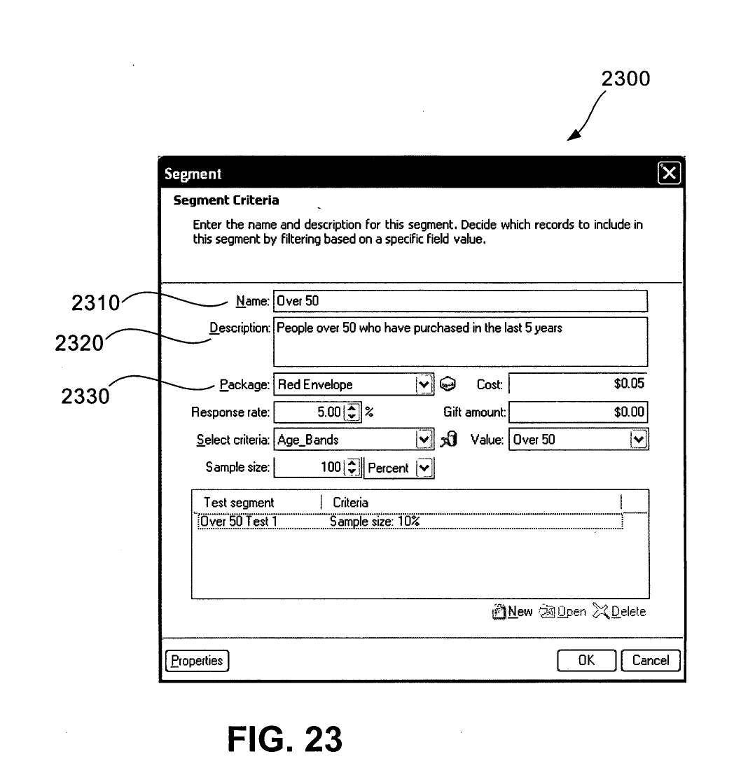

FIGS. 23-29 present another exemplary mailing using the method and system of the present invention. In this example, a test segment is created. For purposes of clarity, the screens presented in this example have been given new reference numerals, although some screens may be similar in appearance to those presented in other examples herein.

To begin the segmentation process, the user is provided with a segmentation criteria input screen 2300, such as that shown in FIG. 23. Each segment definition contains various elements that are input by the user or selected from a list of predefined options. In the example depicted in FIG. 23, the user is asked to designate a name for the segment, for example, “Over 50”, “From Maine”, and so forth, in name field 2310. The user then provides a more detailed description of the segment in the description field 2320 provided. The user then selects a package type 2330, which has been predefined by the user or system administrator.

The user then has the option of creating a test segment. As stated above, test segment may be used to evaluate the effectiveness of a particular package with a particular group without the expense of mailing the package to all members in the group. Although the fundraising process is lengthened by use of test segments, use of a test segment provides valuable information for use in future mailings. For instance, where a given package is particularly costly and the number of members of a segment is particularly large, it might be beneficial to send only 5% of the members the particular package. If the results of the mailing are highly ineffective, only a small amount of money is spent to obtain that information.

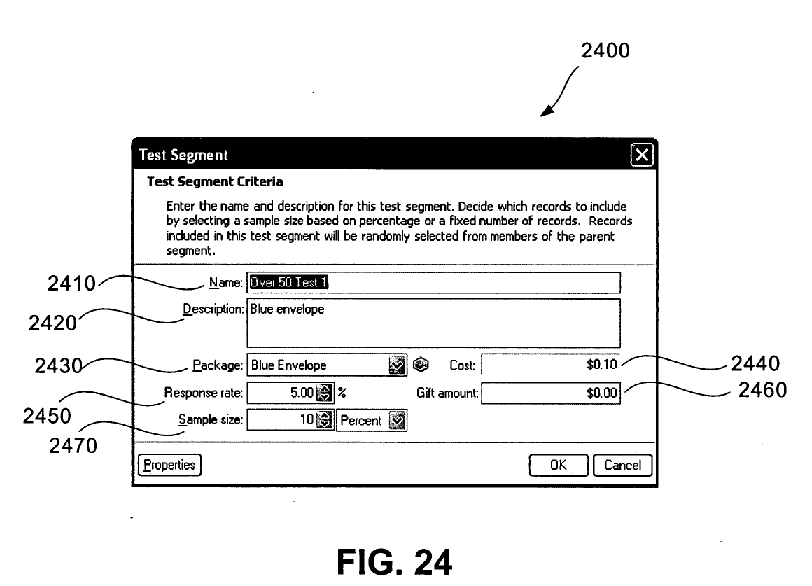

FIG. 24 depicts an exemplary input screen 2400 for defining a test segment. In this instance, the user is asked to provide a name in name field 2410 for the test segment, in this instance, “Over 50 Test 1”, a description of the segment in field 2420, the package type in field 2430, the cost per package in field 2440, expected response rate in field 2450, expected gift amount in field 2460, and sample size in field 2470. Thus, in this example, the user has specified that only 10% of the members of the segment will receive the mailing. No particular expected gift amount has been selected. The particular recipients of the test mailing can be selected in any manner known to those skilled in the art, and in some instances, may be selected randomly.

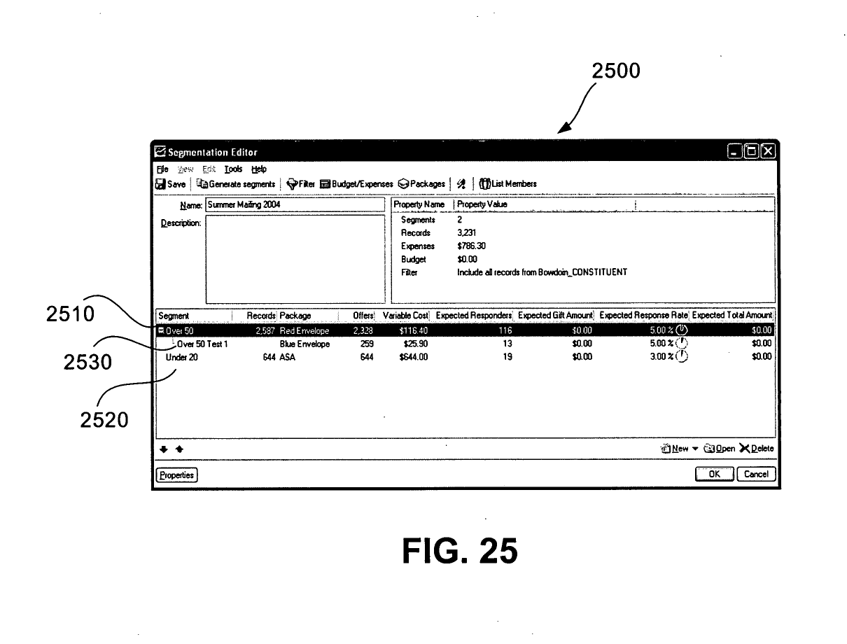

Within the segmentation editor screen 2500, such as that depicted in FIG. 25, segments can be readily edited and arranged as desired. The segmentation editor can be used to rearrange the segments to create a new hierarchy of recipients. In this example, two segments 2510, 2520 and one test segment 2530 have been created. The two segments are “Over 50” and “Under 20”. The test segment is “Over 50 Test 1”.

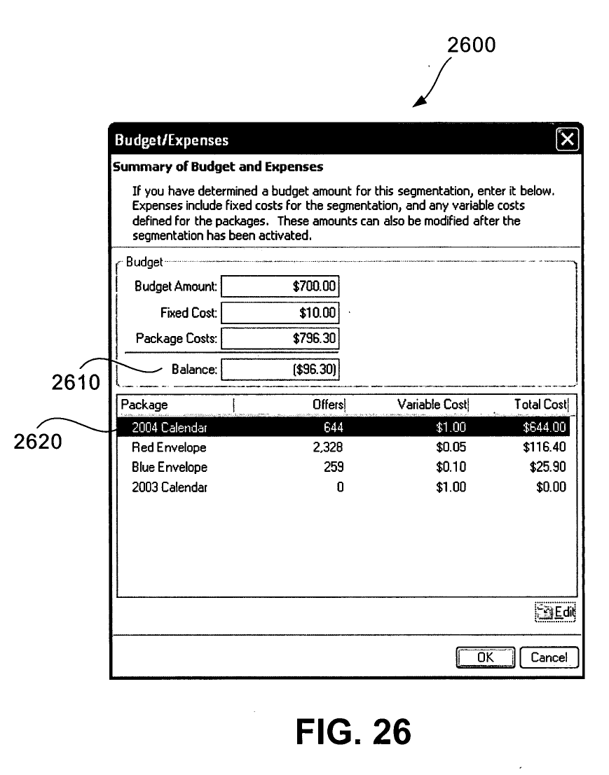

Budget and cost information can be entered using an exemplary screen 2600 for inputting budget/expenses, such as that depicted in FIG. 26. If the total expenses exceed the available budget, resulting in a negative balance 2610 the segments that cannot be fully funded are highlighted. In this instance, the “2004 Calendar” segment 2620 is indicated as being over budget. To maintain a positive or zero balance, the budget amount must then be increased, costs must be reduced (by, for example, decreasing the number of members in a segment), test segments must be added, a less expensive package must be selected, or segments must be deleted.

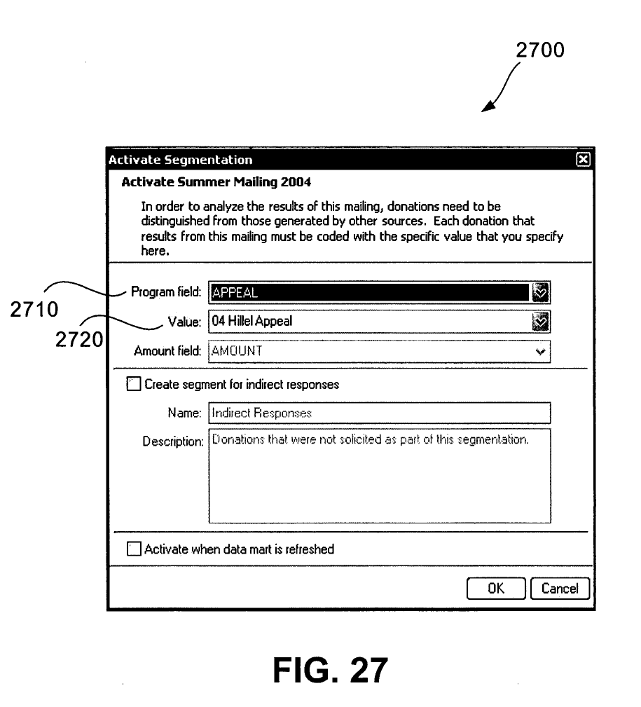

Once the segmentation has been defined and the budget and expense information is reconciled, the mailing is activated. As depicted in FIG. 27, various information is input into an exemplary screen 2700 for activating the segmentation. This information includes a program field 2710 that will identify the type of direct mailing campaign and a value 2720 for the subgroup of program field 2710 selected.

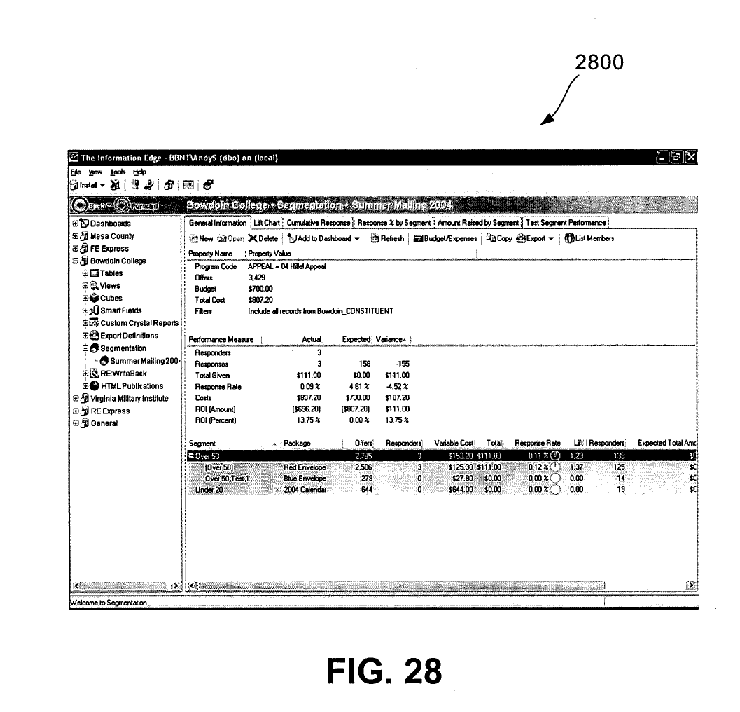

As discussed above, the activation process creates data structures that are optimal for analyzing the results of the mailing. As the results are received, the data structures are updated and the performance of the campaign is tracked. As shown in status screen 2800 of FIG. 28, the system may return values for the total number of responders and purchase/donation amount, return on investment for each segment and for the overall mailing as an amount and a percent, the lift for each segment (i.e., a segment's performance relative to the mailing), and so forth. While various return values are set forth herein, it should be understood that various other values may be calculated by the system of the present invention.

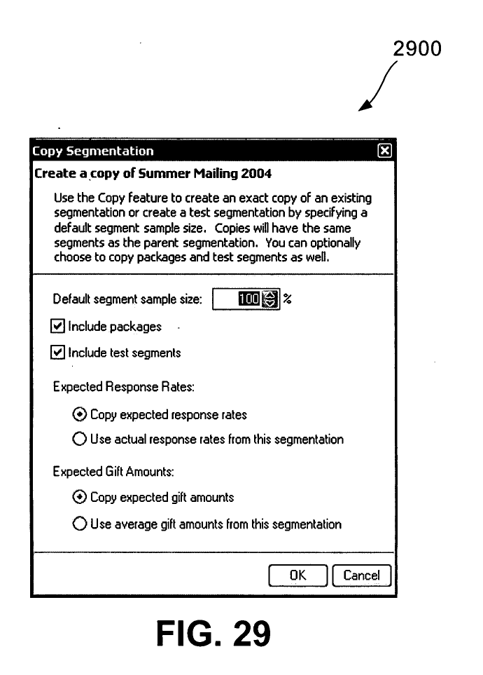

Using the information obtained from the mailing, a subsequent mailing can be refined to optimized results. As shown in FIG. 29, the information from a mailing can be efficiently and readily copied into a new segmentation.

In sum, the present invention is directed to a method system for collecting data and segmenting it to produce a targeted mailing. The system is operative for analyzing the data from a targeted mailing and readily refining a subsequent mailing in light of the previous results. The system of the present invention further enables test segments to be created to evaluate the effectiveness of a particular package to be mailed with a particular group of recipients. The present invention provides significant advantages over presently available data analysis systems, which are unable to capture the data from a previous mailing and incorporate the teachings into future mailings.

The foregoing description has been presented for purposes of illustration and description. It is not intended to be exhaustive or to limit the invention to the precise examples or embodiments disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method of optimizing direct marketing campaigns to pools of potential donors, information about the potential donors stored in a first computer database, comprising the steps of:
defining a plurality of segments for a first direct marketing campaign, wherein each potential donor is a member of no more than one respective segment;
defining and associating a respective package with each segment, each package indicative of the material to be sent to members of the respective segment;
fixing in time a first segmentation comprised of one or more of the segments, information about the first segmentation stored in a second computer database;
sending the respective package to members of the respective segments included in the first segmentation;
associating responses from the members of the respective segments included in the first segmentation with the information about the first segmentation;
based on the responses, calculating a response rate and an average gift amount for each respective segment included in the first segmentation; and
creating a second segmentation comprised of one or more segments included in the first segmentation, each segment in the second segmentation having an expected response rate and an estimated gift amount based on the response rate and the average gift amount for each corresponding segment from the first segmentation.

2. The method of claim 1 wherein the first and second computer databases are the same.

3. The method of claim 1 wherein the first and second computer databases are different.

4. The method of claim 1 wherein the respective package is sent to all members of the respective segment included in the first segmentation.

5. The method of claim 1 further comprising associating a plurality of respective packages with at least one segment.

6. The method of claim 1 wherein the respective package is sent to a subset of members of the respective segments included in the first segmentation.

7. The method of claim 1 wherein each package identifies an envelope type and its contents, and has a cost associated therewith.

8. The method of claim 7 further comprising identifying a total cost associated with the first segmentation based on the costs associated with the packages sent in the first segmentation.

9. The method of claim 7 further comprising identifying a cost for each segment of the first segmentation based on the costs associated with the packages sent to each respective segment of the first segmentation.

10. The method of claim 9 further comprising calculating a rate of return associated with the first segmentation based on a comparison of the costs for each segment and a total gift amount received from each segment.

11. The method of claim 10 further comprising calculating an expected rate of return on the second segmentation based on the rate of return for the first segmentation.

12. The method of claim 9 further comprising calculating a rate of return associated with each respective package of the first segmentation based on a comparison of the costs for each respective package, the number of each respective package sent, and a total gift amount received from members who received each respective package.

13. The method of claim 12 further comprising calculating an expected rate of return on the second segmentation based on the rate of return for the first segmentation.

14. The method of claim 1 further comprising, based on the responses, calculating a total amount given by each respective segment included in the first segmentation.

15. The method of claim 14 further comprising calculating an expected total amount for the second segmentation based on the total amount given in the first segmentation..

16. The method of claim 1 further comprising, based on the responses, calculating a response rate and an average gift amount for each package included in the first segmentation.

17. In a direct marketing campaign system aimed at a pool of potential donors, wherein information about the potential donors is stored in a computer database and wherein a plurality of segments are defined for the direct marketing campaign, a method comprising the steps of:
(a) arranging the plurality of segments into more than one hierarchy;
(b) for each respective hierarchy, assigning each potential donor from the computer database to no more than one respective segment of the respective hierarchy wherein assignment to one of the respective segments is based on the highest segment of the respective hierarchy for which the potential donor qualifies;
(c) calculating an expected return on investment for the campaign for each respective hierarchy;
(d) selecting the hierarchy with the highest expected return on investment as the optimized hierarchy; and
(e) activating a segmentation for the direct marketing campaign having the plurality of segments arranged according to the optimized hierarchy.

18. The method of claim 17 wherein each segment has a respective expected response rate and expected average donation amount, wherein a respective package to be sent to each potential donor is defined and associated with each respective segment, wherein each package has a cost associated therewith, and wherein the direct marketing campaign has a budget, and wherein the step of calculating an expected return on investment for the campaign includes calculating:
(i) the number of potential donors in each respective segment;
(ii) the cost of packaging associated with each respective segment based on the cost of the package associated with the respective segment and the number of potential donors assigned thereto;
(iii) the number of expected responses from each respective segment based on the expected response rate and the number of potential donors in each respective segment;
(iv) a total expected gift amount for each respective segment based on the number of expected responses and the expected average donation amount for the respective segment; and
(v) the return on investment for each respective segment based on the total expected gift amount and the cost of packaging associated with each respective segment in the segmentation.

19. The method of claim 17 wherein step (b) further comprises storing the assignment of each potential donor to the respective segment in temporary computer memory for faster processing of step (c).

20. The method of claim 17 wherein each segment in each respective hierarchy is defined by a specific criteria and an exclusion of the specific criteria for each higher ranked segment in the respective hierarchy for faster processing of step (c).
